(19) United States
(12) Patent Application Publication
(10) Pub. No.: US 2004/0179239 A1
(43) Pub. Date: Sep. 16, 2004

(54) Apparatus for and method of processing image, and computer product

(76) Inventors: Yukiko Yamazaki, Tokyo (JP); Takahiro Yagishita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/797,066

(22) Filed: Mar. 11, 2004

(30) Foreign Application Priority Data
Mar. 11, 2003 (JP) 2003-065787

(51) Int. Cl. G06K 15/02; H04N 1/32; H04N 1/40; G09C 5/00

(52) U.S. Cl. 358/2.1; 358/3.24; 358/426.12; 358/3.28

(57) ABSTRACT

An image processing apparatus includes a first unit that converts image area information related to a predetermined image area of image data into predetermined information and a second unit that attaches the predetermined information to the image data. The predetermined information is coordinates of a rectangle, and the second unit attaches the coordinates to the image data as a tag based on a predetermined format.

### CROSS-REFERENCE TO RELATED APPLICATIONS

The present document incorporates by reference the entire contents of Japanese priority document, 2003-065787 filed in Japan on Mar. 11, 2003.

### BACKGROUND OF THE INVENTION

1) Field of the Invention

The present invention relates to a technology for detecting characteristics of an image, storing the image with the characteristics, processing the image based on the characteristics stored, and outputting the image processed.

2) Description of the Related Art

In image processing apparatuses used in digital copying machines for example, to reproduce an image of high quality image when the image has both a pattern such as a halftone or a photograph, and characters, it is desired that the pattern is subjected to high tone image processing and the characters and line images are subjected to high resolution image processing. Further, it is desired to reproduce an edge area of color characters only with a black color to obtain the image of high quality. Therefore, a technology for reproducing a high quality image by performing image area separation for each image area, and subjecting the image area to an appropriate image processing using a result of the image area separation has been utilized in such an image formation apparatus.

The technology has been utilized conventionally in the digital copying machine in which processes from a point of input to a point of output are integrated. According to the digital copying machine, separation of an image area of scanned data is executed, and a result of the separation is temporarily stored in a memory or the like until image processing is performed. The result is mainly N bits per pixel (a value of N depends on image quality), and an enormous amount of data has to be stored if the resolution is increased. Such a result equivalent to an enormous amount of data can only be processed by expensive copying machines having huge memories and capable of processing heavy loads, the expensive copying machines each in which parts including a scanner and a printer are integrated.

More and more data files are now being electronized and distributed through networks, and thus recently, image data are temporarily stored in storages (for example, hard disks) of digital copying machines to be output later, or the image data temporarily stored are printed out from other output machines connected to the network. The information on image area separation generated by one of the digital copying machine which scans the image is equivalent to a huge amount of data, and a heavy load is thus applied on the network when the information is transmitted together with the image data to another one of the digital copying machines which print the image. Transmission of such enormous data is difficult. Furthermore, in generally used printers, it is difficult to perform such image area separation of a heavy load to output a high-quality image like the image obtained by the digital copying machines.

A digital color copying machine having four drums, which generates image area separation result from image data before compression, and uses the image area separation result at the time of reproducing the image that has been subjected to lossy compression, to obtain an image of high quality has been disclosed for example in the Japanese Patent Publication No. 3176052.

Another apparatus which does not require a very large memory capacity for storing data related to image area separation has been disclosed for example in the Japanese Patent Publication No. 3134756. This apparatus stores image data together with the data related to image area separation that has been efficiently compressed, which are to be subjected to image processing in the subsequent stage. This apparatus has been provided to increase the printout speed without deterioration in the image quality, and to reduce the memory capacity required as much as possible.

The apparatuses disclosed in the publications are provided for efficiently using the image area separation results within the copying machine, and do not take into account how the image is output at other copying machines to which the image data is transmitted over the network.

In such conventional apparatuses, a low quality image is typically output from an output machine because when an image is transferred to the output machine connected to the network, even if data immediately after scanning is read at high resolution, an image converted into an image of low resolution or an image subjected to lossy compression is usually transferred to the output machine to reduce the load on the transfer path of the network.

To reproduce a high-quality image, image area separation data is required. However, according to the conventional apparatuses, the image area separation data requires several bits per pixel or per block, and hence the whole image amounts to a large quantity data. Therefore, to reduce the memory capacity as much as possible, the image area separation data is compressed and temporarily stored to be used at the time of reproduction.

The conventional apparatuses, however, are utilized in the digital copying machine in which the scanner and the printer are integrated. When image data is transferred through the network to be output by an external output machine, the image area separation data is not available at the external output machine. Hence, a high-quality image cannot be printed out by the external output machine. Further, even if the image area separation data is transferred together with the image data, since the amount of the image area separation data is enormous, a heavy load cannot be prevented from being placed on the transfer path.

### SUMMARY OF THE INVENTION

It is an object of the present invention to solve at least the problems in the conventional technology.

An image processing apparatus according to an aspect of the present invention includes a first unit that converts image area information related to a predetermined image area of image data into predetermined information; and a second unit that attaches the predetermined information to the image data.

An image processing apparatus according to another aspect of the present invention includes a first unit that receives image data including a predetermined image area information and an image file to which the predetermined image area information is attached; a second unit that extracts the predetermined image area information from the image data; and a third unit that performs image processing by using the predetermined image area information.

An image processing method according to still another aspect of the present invention includes converting image area information related to a predetermined image area of image data into predetermined information; and attaching the predetermined information to the image data.

A computer-readable storing medium according to still another aspect of the present invention stores a computer program including computer executable instructions which when executed by a computer, cause the computer to realize the method according to the above aspect.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is an illustration of a configuration for transmitting image data according to an embodiment of the present invention;

FIG. 2 is an illustration of a configuration of an image area separator according to the embodiment;

FIG. 3 is a flowchart of a rectangle processing method;

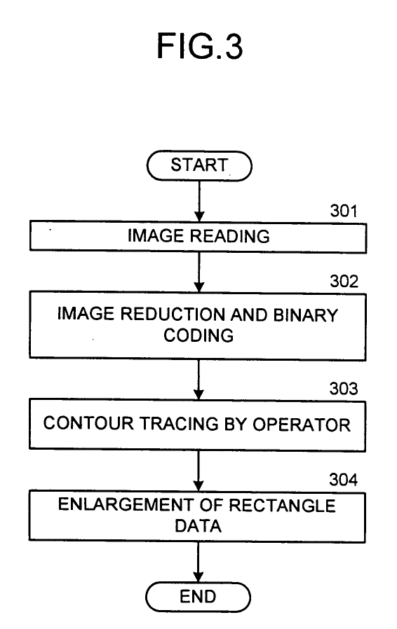

FIG. 4 is an illustration of results of rectangle processing;

FIG. 5 is an illustration of the rectangle processing method;

FIG. 6 is an illustration of a configuration for receiving the image data according to another embodiment of the present invention;

FIG. 7 is an illustration of a configuration for receiving the image data according to still another embodiment of the present invention;

FIGS. 8A and 8B are illustrations of a method of converting separation information to a block;

FIG. 9 is an illustration of a configuration for transmitting the image data according to still another embodiment of the present invention;

FIG. 10 is an illustration of a configuration for receiving the image data according to still another embodiment of the present invention; and

FIG. 11 is an illustration of a configuration for receiving the image data according to still another embodiment of the present invention.

### DETAILED DESCRIPTION

Exemplary embodiments of the present invention will be explained below with reference to the drawings.

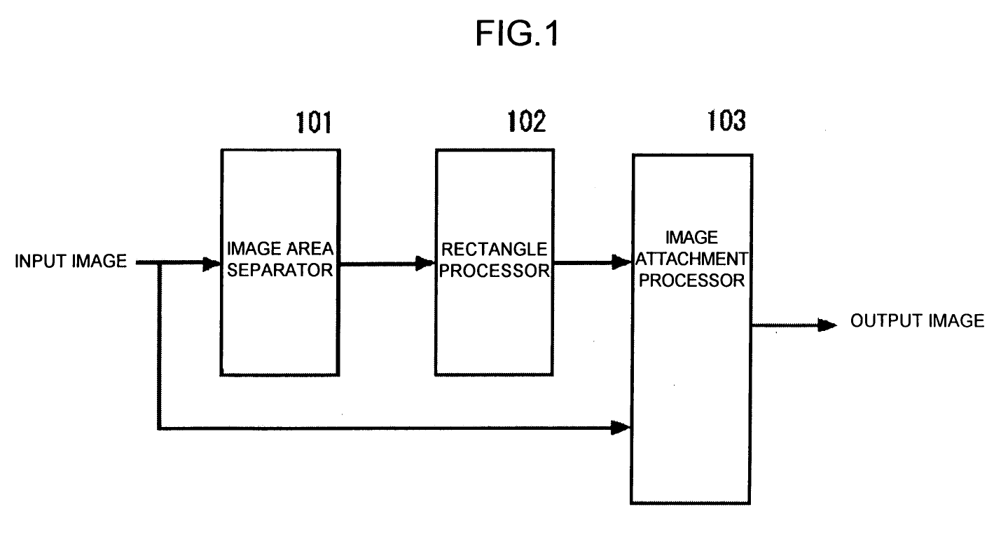

FIG. 1 illustrates a configuration for sending image data according to an embodiment of the present invention. An image area separator 101 detects at least one of a character edge area, a halftone area, and a color area from digital image data fetched by a scanner or generated by a personal computer (PC) and the like. A rectangle processor 102 gathers a plurality of results of image area separation detected to convert the results into coordinates of rectangles. An image attachment processor 103 attaches the coordinates to the digital image data as a tag or by embedding the coordinates in the digital image data.

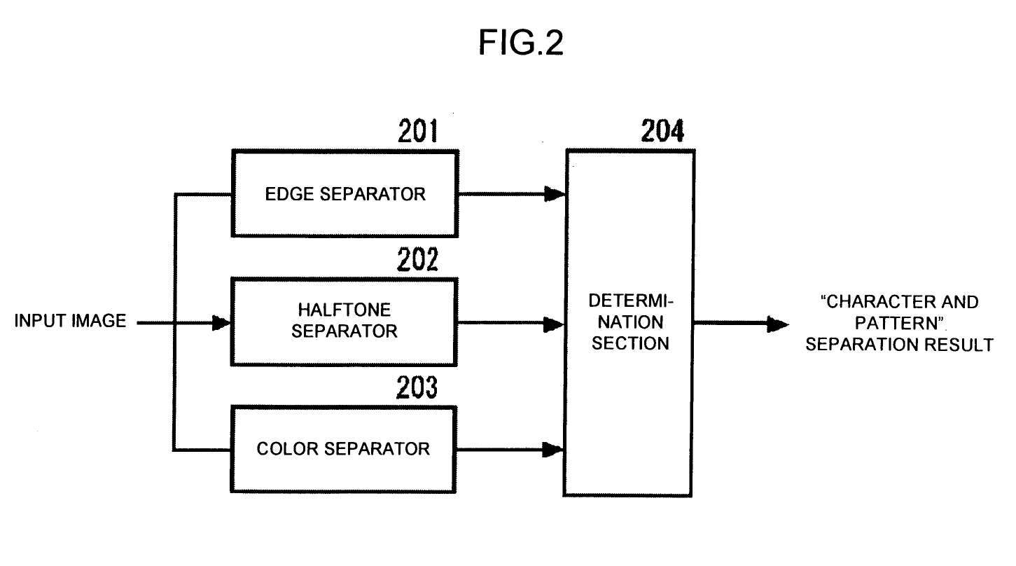

FIG. 2 illustrates a configuration of the image area separator 101. For example, the image area-separator 101 includes an edge separator 201, a halftone separator 202, and a color separator 203. Typically the edge separator separates the edge area pixel by pixel. The halftone separator 202 and the color separator 203 separate the halftone area and the color area respectively block by block. The edge separator 201 is a circuit for detecting character edges in an original document. In the embodiment, the “4.2 Edge Area Detection” method described in a paper titled “Image Area Separation Method for Images Including Both Characters and Patterns (Halftone and Photograph)” (The Transactions of the Institute of Electronics, Information and Communication Engineers, Vol. J75-D2 No. 1, pp. 39 to 47, January 1992, O-uchi et al.) is used as a method of detecting the character edges, for example. According to this method, after image data of 64-gradations is subjected to edge reinforcement, the image data is converted into a ternary value by two kinds of fixed thresholds, and continuity of black pixels and white pixels of the image data converted into the ternary value is detected by pattern matching. If one or more of the black pixels as well as one or more of the white pixels exist within a block of 5×5 pixels, it is determined that the block is an edge area. If not, it is determined that the block is not an edge area. It is important that the separation result is generated pixel by pixel, and a mask for the determination is moved by one pixel for the next determination.

The halftone separator 202 is a circuit for detecting a halftone (printing pattern) area in the original document. In the embodiment, the “4.1 Halftone Area Detection” method described in the paper is used as a method of detecting the halftone. According to the method, the halftone area is separated by detecting a peak pixel and the halftone area and correcting the halftone area, taking into account that density change in the halftone area is largely different from that in a character area. A central pixel at a center of a block of 3×3 pixels for example is detected as the peak pixel, when a density level L of the central pixel is higher or lower than those of all those pixels around the central pixel, and density levels a and b of all four pairs of diagonal pixels sandwiching the central pixel has a relationship defined by an inequality 12×L-a-b|>TH (fixed threshold).

For example, when two or more of four blocks of 4×4 pixels include the peak pixels, the halftone separator 202 determines the two or more as halftone candidate areas, and other of the four blocks as non-halftone candidate areas. After the halftone and non-halftone candidate areas are determined, if four or more of nine blocks surrounding a target block are the halftone candidate areas, the target block is determined as a halftone dot area. If not, the target block is determined as the non-halftone area. The halftone separation result is generated block by block, and a mask for the determination is moved by four pixels for the next determination.

The color separator 203 is a circuit for detecting a chromatic or colored area in the original document. According to the embodiment, the color separator 203 determines whether a target block is colored or not by performing the following two steps. At a first step, the color separator 203 calculates a value max (c-m, m-y, y-c) of the target pixel, and when the value is larger than a predetermined threshold, the target pixel is determined as a colored pixel. At a second step, the color separator 203 counts a number of colored pixels in the target block (4×4 pixels), and when the number is larger than a predetermined threshold, the target block is determined as a colored block. In this color separation, a mask for the determination is shifted by four pixels for the next determination, similarly as in the halftone separation.

Various types of separation can be performed with respect to each image area as described above. The image attachment processor 103 may attach any one of the separation results (edge, halftone, and color) to the digital image data, or as shown in FIG. 2, a determination section 204 may be provided to attach an area determination result obtained by combining the separation results.

The determination section 204 in FIG. 2 receives signals (ON/OFF) of the edge separation result, the halftone separation result, and the color separation result, to make determination as described below. That is, the determination section 204 generates a black character area signal when the edge separation signal is ON, the halftone separation signal is OFF, and the color separation signal is OFF. The. determination section 204 generates a color character area signal when the edge separation signal is ON, the halftone separation signal is OFF, and the color separation signal is ON. The determination section 204 generates a pattern area signal for any other combinations of the separation signals. An image processor for outputting the image performs appropriate processing for each of these areas based on the area signals generated.

An example in which the halftone separator 202 shown in FIG. 2 is replaced by a white ground separation circuit is explained below. The replacement is made for accurately separating only the character edges. According to the example, a large white block which is likely to exist in a background of the characters is detected, and a result of the detection is used in the image area separation. The white ground separation circuit is configured to detect a white block in the vicinity of a target block from the original document. In the example, it is determined whether the target block is a white block through the following three steps. At a first step, a value max (c, m, y) of the target pixel is calculated, and when the value is smaller than a predetermined threshold, the target pixel is determined as a white pixel. At a second step, a number of white pixels in the target block (4×4 pixels) is counted, and when the number is larger than a predetermined threshold, the target block is determined as a candidate for a white ground block. At a third step, if any one of five blocks is determined to be the candidate, the target block is determined as a white ground block. This separation is also performed block by block, and a mask for the determination is shifted by four pixels for the next determination. The determination section 204 receives signals (ON/OFF) of the edge separation result, the white ground separation result, and the color separation result, to perform the following determination. That is, the determination section 204 generates a black character area signal when the edge separation signal is ON, the white ground separation signal is ON, and the color separation signal is OFF, generates a color character area signal when the edge separation signal is ON, the white ground separation signal is ON, and the color separation signal is ON, and generates a pattern area signal for any other combination of the signals.

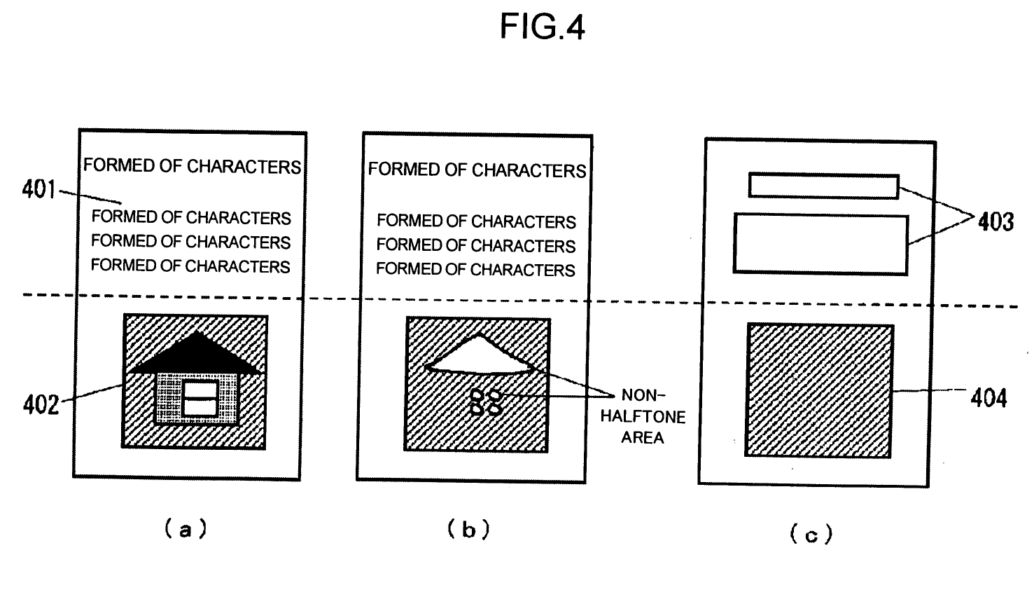

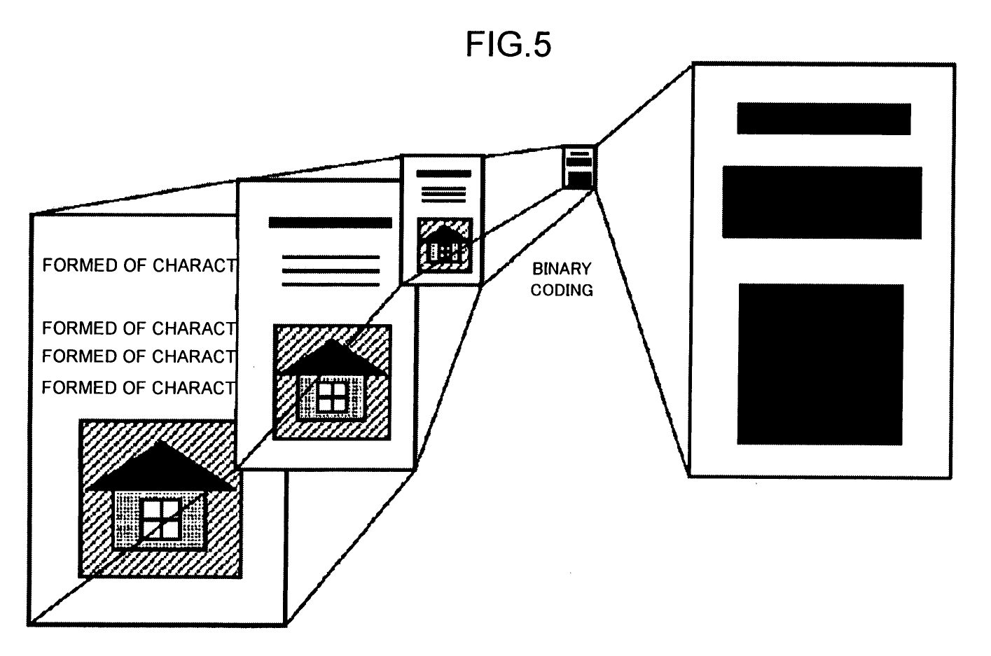

The present invention is not limited to the examples described above, and can be changed in various ways. For example, the edge separation may be performed in blocks of 2×2 pixels, and separation including a character portion 401 and a pattern portion 402 is shown in FIG. 4B. For the sake of explanation, the character portion 401 including characters in an upper half portion corresponds to a result of edge separation, and the pattern portion 402 including a pattern corresponds to a result of halftone separation. The pattern portion 402 with a halftone in the original image exists as a rectangle. However, since the detection of the peak pixel is performed in units of a predetermined block, halftone separation for relatively large solid portions is erroneously performed. That is, the solid portions are erroneously determined as non-halftone areas. Therefore, as shown as the result (b) in FIG. 4, areas determined as OFF areas as the result of halftone separation are scattered to various locations. Since contours of the characters are separated pixel by pixel by performing edge separation of the character portion 401, if there are many spaces between the characters and lines of the characters, many small rectangles may be extracted if the rectangle processing is directly performed on the character portion 401. If such many rectangles are generated, corresponding coordinate information would amount to an enormous quantity of information. In order to avoid the formation of too many rectangles, the erroneous separated areas scattered across the pattern as a result of the halftone separation, and the spaces between the characters and lines are preferably eliminated, to form rectangle areas which are as simple as possible, like a character area 403 and a pattern area 404 shown as a result (c) in FIG. 4C. If the rectangles as in the result (c) are obtained, three sets of rectangle coordinates, which are “character 1 (Xs, Ys)-(Xe, Ye)”, “character 2 (Xs, Ys)-(Xe, Ye)”, and “pattern 1 (Xs, Ys)-(Xe, Ye)” are obtained. As a method of obtaining the rectangle coordinates of the character portion 403, a method as shown in FIG. 5 and described in the above-mentioned paper by Suzue et al. may be used. Before the rectangle processing, the N-valued separation result image is reduced to an extent in which the spaces between the lines and the like are eliminated. After the rectangle processing has been performed with respect to the image reduced, the image is enlarged to the size of the original image to obtain the coordinates. Alternatively, the coordinates for the original image may be calculated based on the reduction rate, without performing the enlargement. The result of determining the areas can be represented by minimum coordinate information.

The image attachment processor 103 shown in FIG. 1 will be explained below. In a first example of method of attaching information to the original image data as a tag, rectangle information separated as a header is attached to a head portion of the original image. For example, for a tiff format or the like, an ID a user is allowed to use is set in the header. The image area separation data can be attached by using the ID. Likewise, the image area separation data can be added to an Exif tag. The Exif tag is described in detail in a section titled “2.6 Tags”, in Japan Electronic Industry Development Association Standard, “Digital Still Camera Image File Format Standard (Exchangeable Image File Format for Digital Still Camera: Exif) Version” (2.1 JEIDA-49-1998). The format of the header is not limited to these examples.

An electronic watermark method, for example, may be used as a method of embedding the information in the image data. The electronic watermark method is a technique for embedding information such that when digital contents embedded with the information are reproduced in the usual way, the information embedded cannot be perceived by human. The digital contents refer to moving images, static images, voices, computer programs, computer data, and the like. If a machine that receives the digital contents has means for extracting the embedded data, the machine can extract and use the embedded data for image processing, by using the technique, to obtain an output of high-quality. Even if the machine does not have the means for extracting the embedded data, and the embedded data is directly output, an output having no problem with its image quality can be obtained.

A typical example of a method of embedding information as an electronic watermark is a method of embedding the electronic watermark by executing calculation on data values of the digital contents, such as hue and lightness of pixels for digital images for example. A typical example of this method is described in U.S. Pat. No. 5,636,292, by Digimarc Corporation, in which the digital contents are divided into blocks, and a predetermined watermark pattern, being a combination of +1 and −1, is added into each of the blocks. Another typical example is a method in which the digital contents are subjected to frequency transform such as Fast Fourier Transform, Discrete Cosine Transform, or Wavelet Transform, and after adding watermark information to the frequency domain, inverse frequency transform is performed. If the Fast Fourier Transform is used, the input contents are added with a PN sequence and defused, and then divided into blocks. Fourier Transform is then performed block by block, and one-bit watermark information is embedded per block. The block in which the watermark information is embedded is subjected to inverse Fourier Transform, and added with the same PN sequence, to obtain the contents embedded with the electronic watermark. This method is described in detail in a paper titled “Watermark Signature Method for Images Using PN-sequence”, 1997, by Ohnishi, Oka, and Matsui, of Conference Papers for Symposium on Cryptography and Information Security, SCIS 97-26B. If the Discrete Cosine Transform is used, the input contents are divided into blocks, and Discrete Cosine Transform is performed for the blocks block by block. After one-bit information is embedded in each of the blocks, the blocks are subjected to inverse transform, to generate contents embedded with the electronic watermark. This method is described in detail in a paper titled “Electronic Watermark Method for Frequency Domain for Copyright Protection of Digital Images”, 1997, by Nakamura, Ogawa, and Takashima, of Conference Papers for Symposium on Cryptography and Information Security, SCIS 97-26B. If the Wavelet Transform is used, it is not required to divide the input contents into blocks. The method using the Wavelet Transform is described in detail in a paper titled “Experimental Study Related to Safety and Reliability of Electronic Watermark Technique Using Wavelet Transform”, 1997, by Ishizuka, Sakai, and Sakurai, of Conference Papers for Symposium on Cryptography and Information Security, SCIS 97-26B. The known methods such as those described above can be used for embedding the information to the image data.

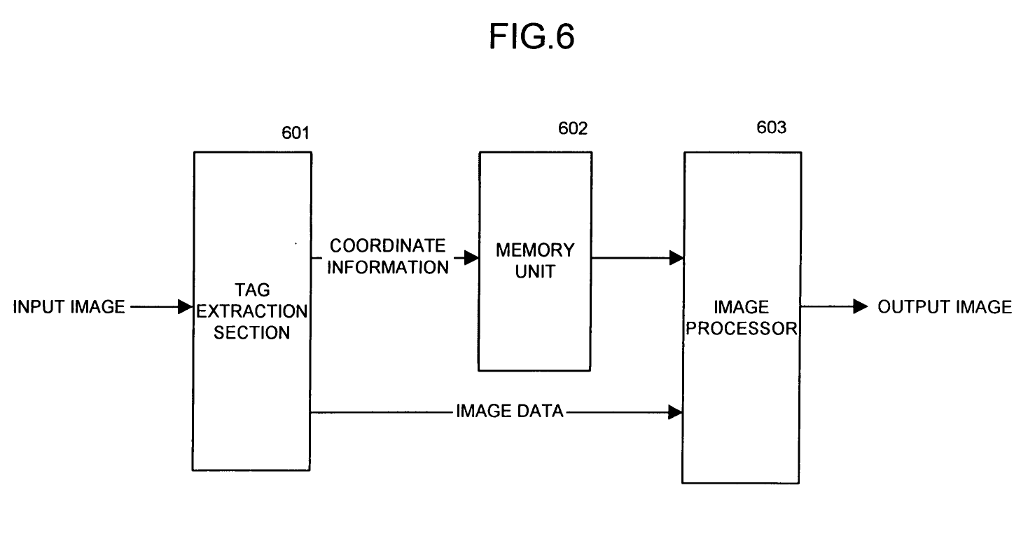

FIG. 6 is an illustration of a configuration for receiving image files according to still another aspect of the present invention. An image file to which image area separation information is attached as a tag is received from a structure for sending the image file. A tag extraction section 601 is configured to extract the image area separation information stored as the tag, and stores the image area separation information extracted into a memory unit 602. An image processor 603 uses the image area separation information stored in the memory 602 to perform various kinds of image processing. The various kinds of image processing are those typically performed by printers. When the input image is represented by an RGB (red, green, and blue) signal, the RGB signal is converted to a CMY (cyan, magenta, and yellow) signal of a linear density by Log conversion. The image area separation information temporarily stored in the memory unit 602 is subjected to processing such as filtering using a smoothing filter and an edge enhancement filter, under color removal (hereinafter, “UCR”) for subtracting a K signal from a signal of each color material, and tone processing for representing halftone by dithering for characters and patterns or by error diffusion, to obtain an output image. Alternatively, if the configuration for receiving the image files does not have such image processing means, the image data may be output without using the image area separation information.

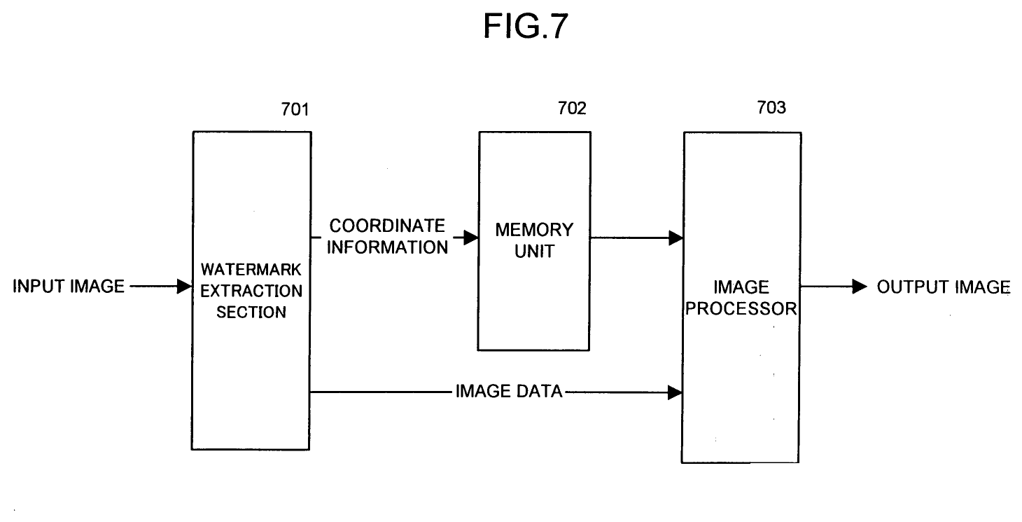

If the image area separation information is stored in the image data as a watermark, a watermark extraction section 701 in FIG. 7 extracts the image area separation information, and an image processor 703 uses the image area separation information as in the above example related to the tag. If the configuration for receiving the image files does not have any image processing means configured to use the image area separation information or does not have any watermark extraction means, the image data may be output without performing the watermark extraction and without using the image area separation information.

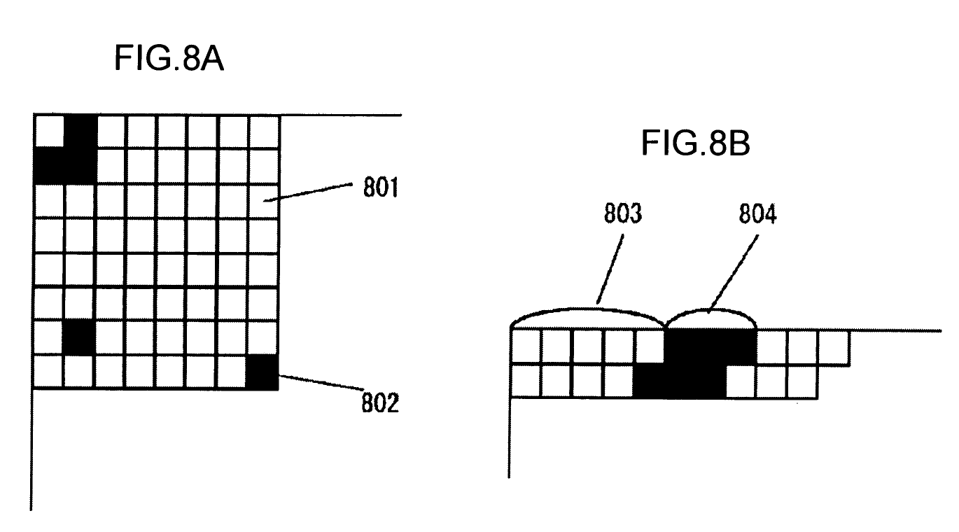

If the information generated by the determination section 204 in FIG. 2 is information in units of a pixel, the separation result can be united in one as a predetermined block size, for example, a block of 8×8. That is, if the separation result generated by the determination section 204 in FIG. 2 is like the one shown in FIG. 8A, either one of the character area and the pattern area having a larger total number of pixels is used as the separation result. Since the 8×8 block shown in FIG. 8A has more pixels belonging to a white pattern area 801 than those belonging to a black edge area 802, the block is determined as a pattern area. When embedding is performed on a frequency space using the Discrete Cosine Transform, one bit of the separation result obtained for a unit of 8×8 block is embedded in a DCT block. The area separation results can be united in a block size depending on the embedding method as described above, or the separation results may be generated in units of any block size and similarly embedded block by block.

When the result obtained by uniting or combining the separation results in units of an 8×8 block is like the one shown in FIG. 8B, five consecutive white pixels, that is, a pattern area 803, and three consecutive black pixels, that is, an edge area 804 are compressed by run-length compression, and the data compressed may be attached as a tag. Not only the run-length compression, but also any other compression methods may be used, but lossless compression methods are preferred.

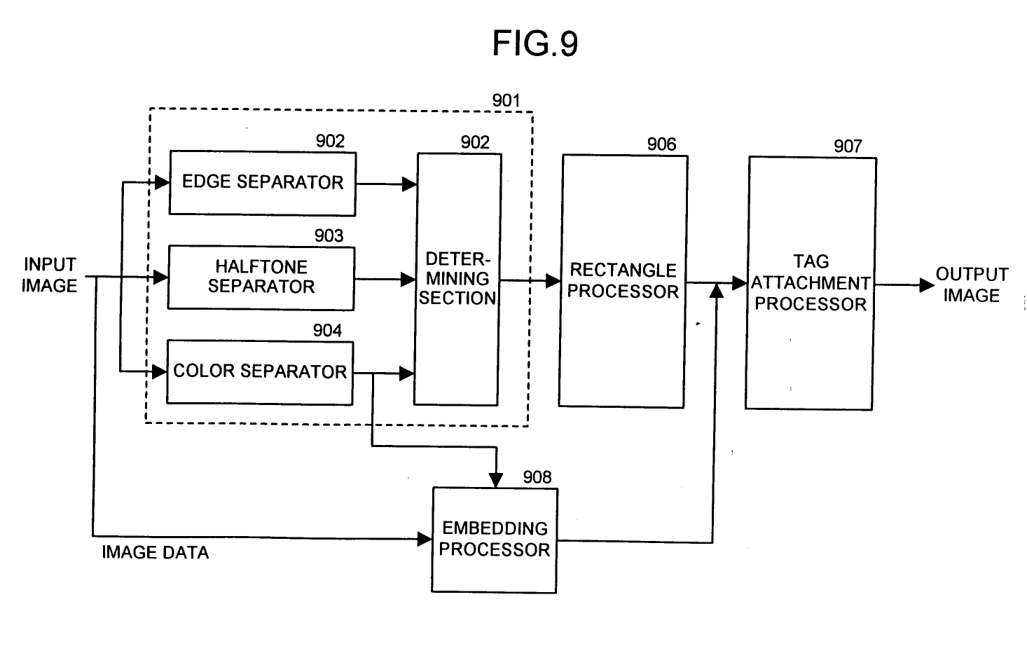

FIG. 9 is an illustration of a configuration for sending image files according to still another embodiment of the present invention. An image area separator 901 includes an edge separator 902, a halftone separator 903, and a color separator 904. A determination section 905 receives information and determines characters and patterns. A rectangle processor 906 subjects a result of the determination to the rectangle processing and converts the coordinate information into a tag format.

An embedding processor 908 receives the output of the color separator 904 and the image data, to embed the output in the image pixel by pixel or block by block. A tag attachment processor 907 attaches tag information to the image embedded with the output, to generate an output image.

Character and pattern areas that are easily obtained as rectangle information may be stored as tags, and information that is likely to diffuse and difficult to unite as large rectangle information (for example, color separation information) may be embedded in the image by the embedding processor 908. By attaching the information to the image, means for receiving the image can separate the image into three types of areas, “a pattern area, a black character area, and a color character area”, which may be used in image processing by an output unit, such that image quality can be improved even more.

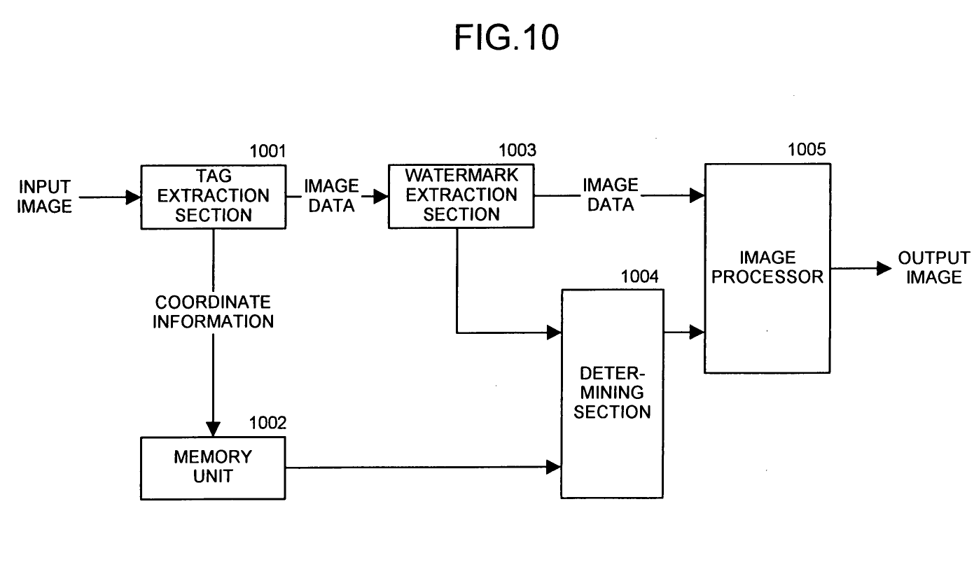

FIG. 10 is an illustration of a configuration for receiving image files according to still another embodiment of the present invention. A tag extraction section 1001 receives the image file generated by the method illustrated in FIG. 9, extracts the image area separation result attached to the header, and temporarily stores the coordinate information in a memory unit 1002. A watermark extraction section 1003 extracts the color separation result. A determination section 1004 separates the image into “a pattern area, a black character area, and a color character area”, based on the color separation result extracted, together with the pattern and character separation result temporarily stored in the memory unit 1002. An image processor 1005 receives a result of the separation performed by the determination section, changes the strength of the filter according to the pattern or the character, and changes the dither matrix by the tone processing. In the UCR, processing for changing the black character area to a single color K according to the black character and the color character is carried out. Thus, appropriate processing can be performed according to the area, to improve the image quality. Even if means for receiving the image files does not have means corresponding to all of the means described above (i.e., various image processing means such as filters, UCR, and dithering), only the tone processing method may be changed by using only the information that is applicable, for example, only the character and pattern separation result, to improve the image quality.

In this embodiment, the information stored as the tag is the character and pattern separation information, and the embedded information is the color separation result. However, the present invention is not limited to this embodiment, and other separation results may be stored as a tag or embedded information.

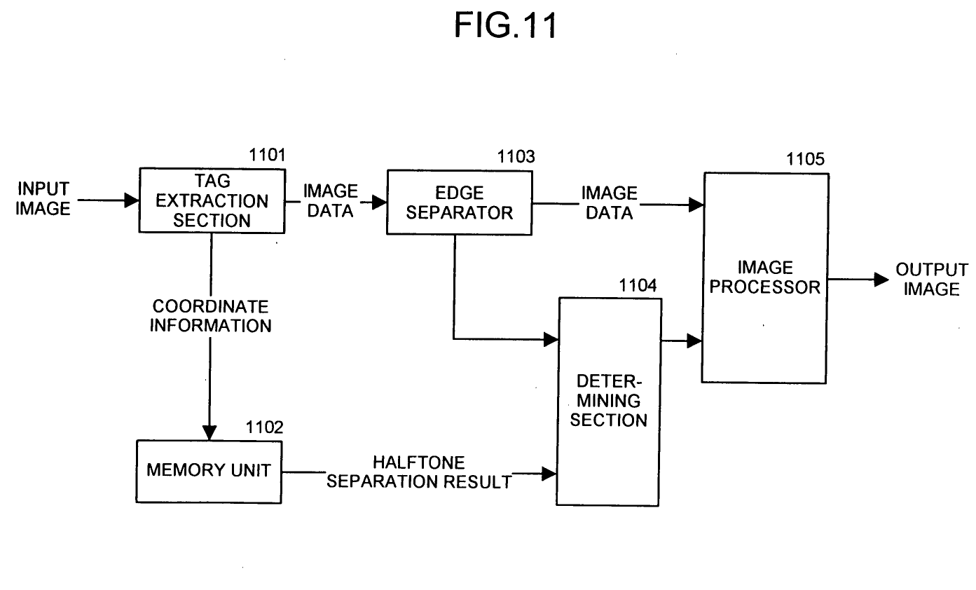

FIG. 11 is an illustration of a configuration for receiving image files according to still another embodiment of the present invention. According to this embodiment, the configuration receives image data attached with the halftone separation information as the tag is converted to a lower-resolution image of low quality by JPEG compression or resolution conversion so as to reduce the load on the communication line. Images subjected to JPEG compression or resolution conversion to a lower resolution generally have ruined halftone contours and low separation accuracy. Therefore, the halftone separation result is stored by being embedded in the header or as a watermark, when the data is still of high-quality before being subject to compression or resolution conversion.

A tag extraction section 1101 extracts the halftone separation information attached as a tag, and the coordinate data is temporarily stored in a memory unit 1102. An edge separator 1103 receives the image data and extracts the edge area pixel by pixel. Even if the image data has been subjected to JPEG or resolution conversion to a lower resolution, strong edge portions can be stored, and hence the edge area can be extracted by the edge separator 1103. A determination section 1104 determines characters and patterns, based on the halftone separation result stored in the memory unit 1102 and the edge separation result. An image processor 1105 uses a result of the determination for filtering, UCR, and tone processing, to perform appropriate image processing and obtain a high-quality output image.

If conversion such as format conversion has been performed, a portion stored as a tag may be interpreted into another header format, such that the information can be stored.

According to the present invention, the image area separation information is changed to the rectangle coordinate information, such that the quantity of the information on the image area separation can be reduced. Therefore, the information can be attached to the image, by using the file tag or the watermark. Since the information can be attached to the image, the information can be transmitted to an output machine via the network, and the output machine can use the information to output a high-quality image without having to perform the image area separation.

Further, according to the present invention, the image area separation information is converted into blocks of a predetermined size. Accordingly, the amount of the image area separation information can be reduced. Moreover, by compressing the data, the quantity can be further reduced, and attached to the image by using the file tag or the watermark. Further, the embedding can be also simplified by handling the blocks of a size equal to that of the block encoding such as the compression.

Furthermore, according to the present invention, since the respective separation results are attached to or embedded in the image, the output machine on the receiver side can use the information attached. Moreover, the output machine can output a high-quality image without having to perform the image area separation.

What is more, according to the present invention, since the area separation result determined by using various separation results is attached to or embedded in the image, the output machine on the receiver side can use the information attached. Further, the output machine can output a high-quality image without having to perform the image area separation.

In addition, according to the present invention, a part of the image area separation information is attached to the image as a tag, and other parts of the image area separation information are embedded in the image as the watermark. That is, the separation information for which the rectangle processing is difficult is embedded in the image, and the information for which the rectangle processing is easy is attached to the image as the tag. As a result, an increase in the capacity of the whole file is prevented, and a large quantity of image area separation information can be stored together with the image.

Moreover, according to the present invention, the output machine on the receiver side extracts the image area separation information, which has been attached as the tag of the input image file received or embedded in the image data as the watermark. Accordingly, the image processor in the output machine can use the image area separation information. The output machine can also output a high-quality image without having to perform the image area separation.

Furthermore, according to the present invention, when the image area separation information that has been generated with a high-resolution image is attached to the image, for example, as the tag, and transmitted, processing such as JPEG compression or resolution conversion to a lower resolution is usually performed to convert the image into a different image. Accordingly, since a predetermined image area property such as a strong edge portion is likely to be successfully stored, such information that is likely to be stored is not attached, and the information with a large loss (for example, the halftone separation information) is attached to the image as the tag. Therefore, only the minimum information required is transmitted, and the receiver side performs separation such as the edge separation to perform image processing. As a result, the capacity of the image file transmitted can be decreased as much as possible, and the output machine can output a high-quality image.

Further, according to the present invention, even if the resolution conversion, the lossy compression, or the format conversion has been performed at the time of transmission, the output machine can output a high-quality image.

In other words, according to the present invention, the image area separation data, which amount to a huge quantity, is converted into the rectangular coordinates. Accordingly, the amount of data can be decreased, and the data decreased can be attached to the image data as a tag or embedded in the image data, to be stored temporarily together with the image data. As a result, even general printers having no means for performing the image area separation are able to print out the image data transmitted through the network, using the image area separation data that has been stored with the image data to reproduce a high-quality image.

In addition, according to the present invention, the image data received by the output machine may be of low quality having been subjected to the resolution conversion or the lossy compression, as long as the image area separation data is generated from the image data before the image data is converted to the image of the low-quality, and the image area separation data is transmitted together with the image, and the output machine has means for processing the image area separation such as only the edge separation. Consequently, the output machine can perform the image processing using both the image area separation result generated by the output machine from the low-quality image and the image separation result transmitted through the network to reproduce and output a high-quality image.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus comprising:
a first unit that converts image area information related to a predetermined image area of image data into predetermined information; and
a second unit that attaches the predetermined information to the image data.

2. The image processing apparatus according to claim 1, wherein
the predetermined information is coordinates of a rectangle, and
the second unit attaches the coordinates to the image data as a tag based on a predetermined format.

3. The image processing apparatus according to claim 1, wherein
the predetermined information is coordinates of a rectangle, and
the second unit attaches the coordinates to the image data by embedding the coordinates in the image data.

4. The image processing apparatus according to claim 1, wherein
the predetermined information is a predetermined block of the image area information, and
the second unit attaches the predetermined block to the image data by embedding the predetermined block in the image data.

5. The image processing apparatus according to claim 1, wherein
the predetermined information is a predetermined block of the image area information, and
the second unit attaches the predetermined block to the image data as a tag based on a predetermined format.

6. The image processing apparatus according to claim 5, wherein the predetermined block is compressed, and the second unit attaches the predetermined block that has been compressed to the image data as the tag.

7. The image processing apparatus according to claim 1, wherein the image area information is a result of halftone area separation.

8. The image processing apparatus according to claim 1, wherein the image area information is a result of white ground area separation.

9. The image processing apparatus according to claim 1, wherein the image area information is a result of color area separation.

10. The image processing apparatus according to claim 1, wherein the image area information is a result of edge area separation.

11. The image processing apparatus according to claim 1, wherein the image area information is a combination of a plurality types of results of image area separation.

12. The image processing apparatus according to claim 1, wherein
the predetermined information is coordinates of a rectangle,
the second unit attaches the coordinates to the image data as a tag based on a predetermined format, and
the image processing apparatus further comprises a third unit that embeds other information other than the predetermined information into a predetermined block of the image data.

13. The image processing apparatus according to claim 12, wherein the image area information, and the other information each is any one of results of halftone area separation, white ground area separation, color area separation, and edge area separation, and a combination of a plurality types of results of image area separation.

14. An image processing apparatus comprising:
a first unit that receives image data including a predetermined image area information and an image file to which the predetermined image area information is attached;
a second unit that extracts the predetermined image area information from the image data; and
a third unit that performs image processing by using the predetermined image area information.

15. The image processing apparatus according to claim 14, wherein the predetermined image area information is attached to the image file as a tag.

16. The image processing apparatus according to claim 14, wherein the predetermined image area information attached to the image file is embedded in the image file as a watermark.

17. The image processing apparatus according to claim 14, wherein
the first unit receives the image data that has been converted into another image data having characteristics different from characteristics of the image data,
the image processing apparatus further comprises:
a fourth unit that obtains other image area information from the another image data; and
a fifth unit that determines characteristics of a predetermined area based on the predetermined image area information and the other image area information, and
the third unit performs the image processing using the characteristics determined by the fifth unit.

18. The image processing apparatus according to claim 17, wherein the another image data is the image data that has been subjected to resolution conversion.

19. The image processing apparatus according to claim 17, wherein the another image data is the image data that has been subjected to lossy compression.

20. An image processing method comprising:
converting image area information related to a predetermined image area of image data into predetermined information; and
attaching the predetermined information to the image data.

21. The image processing method according to claim 20, wherein
the predetermined information is coordinates of a rectangle, and
the attaching is performed by attaching the coordinates to the image data as a tag based on a predetermined format.

22. The image processing method according to claim 20, wherein
the predetermined information is coordinates of a rectangle, and
the attaching is performed by embedding the coordinates in the image data.

23. The image processing method according to claim 20, wherein
the predetermined information is a predetermined block of the image area information, and
the attaching is performed by embedding the predetermined block in the image data.

24. The image processing method according to claim 20, wherein
the predetermined information is a predetermined block of the image area information, and
the attaching is performed by attaching the predetermined block to the image data as a tag based on a predetermined format.

25. A computer readable recording medium that stores a computer program including computer executable instructions which when executed by a computer, cause the computer to perform:
converting image area information related to a predetermined image area of image data into predetermined information; and
attaching the predetermined information to the image data.

26. The computer readable recording medium according to claim 25, wherein
the predetermined information is coordinates of a rectangle, and
the attaching is performed by attaching the coordinates to the image data as a tag based on a predetermined format.

27. The computer readable recording medium according to claim 25, wherein
the predetermined information is coordinates of a rectangle, and
the attaching is performed by embedding the coordinates in the image data.

28. The computer readable recording medium according to claim 25, wherein
the predetermined information is a predetermined block of the image area information, and
the attaching is performed by embedding the predetermined block in the image data.

29. The computer readable recording medium according to claim 25, wherein
the predetermined information is a predetermined block of the image area information, and
the attaching is performed by attaching the predetermined block to the image data as a tag based on a predetermined format.
